(19) United States
(12) Patent Application Publication
(10) Pub. No.: US 2022/0129968 A1
(43) Pub. Date: Apr. 28, 2022

(54) METHODS AND PROCEDURES FOR CREATING, MONITORING, AND UPDATING AN ORGANIZED SHOPPING LIST

(71) Applicant: LifeStyle Logic, LLC, Signal Mountain, TN (US)

(72) Inventors: Curtis S. Koontz, Signal Mountain, TN (US); Jonathan Eckelberry, Elgin, TX (US)

(21) Appl. No.: 17/511,189

(22) Filed: Oct. 26, 2021

Related U.S. Application Data
(60) Provisional application No. 63/106,550, filed on Oct. 28, 2020.

(51) Int. Cl. G06Q 30/06

(52) U.S. Cl. CPC G06Q 30/0633; G06Q 30/0639

(57) ABSTRACT

Disclosed is a system for generating an organized shopping list. The system includes a remote database; a remote server configured to access the remote database; and a local device coupled to the remote server. The local device compares a list of purchase items with a list of items stored in the remote database, generates a list of items that are on the remote database for the selected store and a list of items that are missing from the remote database for the selected store, calculates an efficient order to gather the purchase items that are on the remote database, and generates an organized list of the purchase items detailing their location in the store using the calculated order. The purchase items not on the remote database require a location to be added. The local device validates that the item was in the location. The remote server updates the remote database.

### CROSS-REFERENCE TO RELATED APPLICATIONS

This application claims the benefit of priority under 35 U.S.C. § 119(e) to U.S. Provisional Patent Application Ser. No. 63/106,550, titled METHODS AND PROCEDURES FOR CREATING, MONITORING, AND UPDATING AN ORGANIZED SHOPPING LIST, filed Oct. 28, 2020, the disclosure of which is herein incorporated by reference in its entirety.

### BACKGROUND

The present disclosure relates to generating an organized shopping list that provides an efficient order to gather items in a store. Shopping can be time consuming and inefficient, especially in an unfamiliar store. Some stores, such as Walmart and Kroger, have inventory location as a part of their mobile software applications to help shoppers locate items. Others stores, such as Target, have online inventory data that can tell a customer whether an item is in stock. Additionally, there are shopping specific mobile software applications that attempt to help shoppers organize their shopping list based on broad categories (e.g. bread, dairy, produce, etc.). However, there are no mobile software applications or software that specifically creates, monitors, and updates an organized shopping list based on item locations. Such a mobile software application would allow a shopper to efficiently walk down aisles in an orderly manner to select the items on the organized list. Ultimately, the shopper can complete the shopping batch, while never having to back track through the store.

### SUMMARY

In one general aspect, the present disclosure provides a system to enable a shopper to generate an organized list of items to purchase from a store. The items are ordered in an efficient manner providing locations in the store to allow the shopper to gather the items effectively.

In another aspect, the present disclosure provides a system for generating an organized shopping list. In one aspect, the system comprises a remote database, a remote server configured to access content stored in the remote database, and a local device coupled to the remote server by a network. The local device comprises an input tool for entering items to purchase, and a display. In response to selecting a store to purchase the items, the local device is configured to communicate with the remote server to access the remote database, compare a list of purchase items with a list of items stored in the remote database, and generate a list of items that are on the remote database for the selected store and a list of items that are missing from the remote database for the selected store. In response to selecting a store to purchase the items, the local device is further configured to calculate an efficient order to gather the purchase items that are on the remote database for the selected store, and generate an organized list of the purchase items detailing their location in the store using the calculated order, wherein purchase items not on the remote database for the selected store do not have a location and require one to be added. In response to selecting an item on the organized list as located with the input tool, the local device is configured to validate that the item was in the appropriate location with the input tool, and send the validated item location to the remote server, wherein the remote server updates the remote database.

In another aspect, the present disclosure provides a device to generate an organized shopping list for a batch of items to be purchased at a selected store. In one aspect, the device comprises a processor, a memory, a display, and an input tool. In response to entering purchase items with the input tool and selecting a store to purchase the items the device is configured to communicate with a remote server through a network to access a remote database, compare the list of purchase items with a list of items stored in the remote database, and generate a list of items that are stored in the remote database for the selected store and a list of items that are missing from the remote database for the selected store. In response to entering purchase items with the input tool and selecting a store to purchase the items the device is further configured to calculate an efficient order to gather the purchase items that are on the remote database for the selected store, and generate an organized list of the purchase items detailing their location in the store using the calculated order, wherein purchase items not on the remote database for the selected store do not have a location and require one to be added. In response to selecting an item on the organized list as located with the input tool, the device is configured to validate that the item was in the appropriate location with the input tool, and send the validated item location to the remote server, wherein the remote server updates the remote database.

In yet another aspect, the present disclosure provides a device that generates an organized shopping list when provided items and a store to purchase the items, the device is configured to communicate with a remote server through a network to access a remote database, compare a list of purchase items with a list of items stored in the remote database, and generate a list of items that are on the remote database for the selected store and a list of items that are missing from the remote database for the selected store. The device is further configured to calculate an efficient order to gather the purchase items that are on the remote database for the selected store, and generate an organized list of the purchase items detailing their location in the store using the calculated order, wherein purchase items not on the remote database for the selected store do not have a location and require one to be added, validate that an item was in the appropriate location, and send a validated item location to the remote server, wherein the remote server updates the remote database.

### BRIEF DESCRIPTION OF THE FIGURES

The novel features of the various aspects are set forth with particularity in the appended claims. The described aspects, however, both as to organization and methods of operation, may be best understood by reference to the following description, taken in conjunction with the accompanying drawings in which:

FIG. 1 is a flow diagram of an organized shopping list mobile software application, according to at least one aspect of the present disclosure.

FIG. 2 is a diagram of a shopper's actions, according to at least one aspect of the present disclosure.

FIG. 3 is a diagram of functionality of an organized shopping list mobile software application, according to at least one aspect of the present disclosure.

FIG. 4 is a diagram of a data stored in a remote database, according to at least one aspect of the present disclosure.

FIG. 5 is a diagram of an example implementation of an organized shopping list mobile software application, according to at least one aspect of the present disclosure.

FIG. 6 is an example user interface displaying multiple shopping lists, according to at least one aspect of the present disclosure.

FIG. 7 is an example user interface displaying the creation of a new shopping list, according to at least one aspect of the present disclosure.

FIG. 8 is an example user interface displaying a new shopping list, according to at least one aspect of the present disclosure.

FIG. 9 is an example user interface displaying searching for items to add to a shopping list, according to at least one aspect of the present disclosure.

FIG. 10 is an example user interface displaying searching for items to add to a shopping list, according to at least one aspect of the present disclosure.

FIG. 11 is an example user interface displaying searching for items to add to a shopping list, according to at least one aspect of the present disclosure.

FIG. 12 is an example user interface displaying items added to a shopping list, according to at least one aspect of the present disclosure.

FIG. 13 is an example user interface displaying an organized shopping list based on retrieving the items from a store, according to at least one aspect of the present disclosure.

FIG. 14 is an example user interface displaying an organized shopping list based on retrieving the items from a store, according to at least one aspect of the present disclosure.

FIG. 15 is an example user interface displaying updating or adding an item location in a store, according to at least one aspect of the present disclosure.

### DESCRIPTION

The present disclosure provides a description of a system that takes an unorganized shopping list and organizes the list based on the locations of the items in a selected store. The initial location of an item in a specific store is entered by a shopper, a stores' representative, or another vendor and the location data is uploaded to a remote database. Overtime the database of item locations for specific stores will grow and eventually entire store inventories and item locations will be stored in the remote database. The system uses the item locations stored in the remote database to take an unorganized item list and organize it to allow a shopper to find the items efficiently in the store without back tracking. In the event that an item moves in the store, the shopper, stores' representative, or another vendor finds where the item moved to and enters the new location into the system. The system then updates the item's location in the remote database so that the generated organized lists can be as accurate as possible.

In one general aspect, the present disclosure provides a software application for a mobile device or personal computer that can take an electronic or digital list of items, merge the list with a specific store based on location (e.g. store address, GPS data, or other location tracking method), and then use the inventory data (e.g. Stock Keeping Unit (SKU), Universal Product Code (UPC), Department Class Item (DPCI) numbers, etc.) through the software application's database to create an orderly, organized shopping list. Shoppers', store representatives, or another vendor's activities and input (e.g. scanning the item bar code) will continuously be monitored and used to update the database so that the software application will always know the exact location and details of an item in the store.

In one general aspect, the present disclosure enables a shopper to create an unorganized shopping list using a smart device or something similar. This list will be randomly itemized at the time of creation and will be continuously be updated until the time the shopper goes to the store. Once the shopper decides to go purchase his/her batch of items, they will select the store and its location based on general GPS data or other location tracking methods. Once at the store, the item will need to be found initially by a shopper (not necessarily the current shopper). The item can be scanned using the bar code and a QR scanner on the phone. The item data will be collected and the shopper, store representative, or other vendor will input the location into the mobile application. This location data will then be collected, transferred and stored in a specific store's database created by LifeStyle Logic, LLC, a store's representative, or another vendor. This action will continue for each item on the list. Over time, using crowd sourcing data acquisition or other data acquisition techniques, a detailed database for all items in the store will be created. Ultimately, the entire store's inventory and location will be in the store specific database. Once this is achieved, the next time the shopper goes to that specific store, the shopper can merge the unorganized list with the mobile application and database. The mobile application will then create an organized, orderly shopping list that allows the shopper to gather their items efficiently. In an event that an item is not in the previously noted location, the shopper, store representative, or another vendor can find the respective item, rescan the barcode and update the item's location in the database for the next visit or shopper to use. Additionally, a store worker or someone other than a shopper could use the software to locate all the items in a store and upload them to the database.

Accordingly, the present disclosure provides a software application for a shopping software application for mobile or fixed devices to create an organized list. The present disclosure further provides inventory location software that works with the shopping software application. The present disclosure further provides a functional user interface for the mobile or fixed device. Using the shopping software application, item data is collected for several stores locations using their GPS location or other location tracking software to create a specific store database that can be continuously monitored and updated. The other location tracking system could be any indoor or outdoor tracking position system. Some non-limiting examples of tracking position systems could be based on GPS, QR code, radio-frequency identification (RFID), near-field communication (NFC), Bluetooth Low Energy (BLE) Beacon, WIFI, ultra wide-band, acoustic, or proximity just to provide a few examples. For example a WIFI based tracking position system would work by have a device detect multiple WIFI access points to generate a position. In general, the other location tracking method could be any method that can collect the physical location of an item in the store. The shopping software application and user interface may be provided for use on a personal computer and online versions.

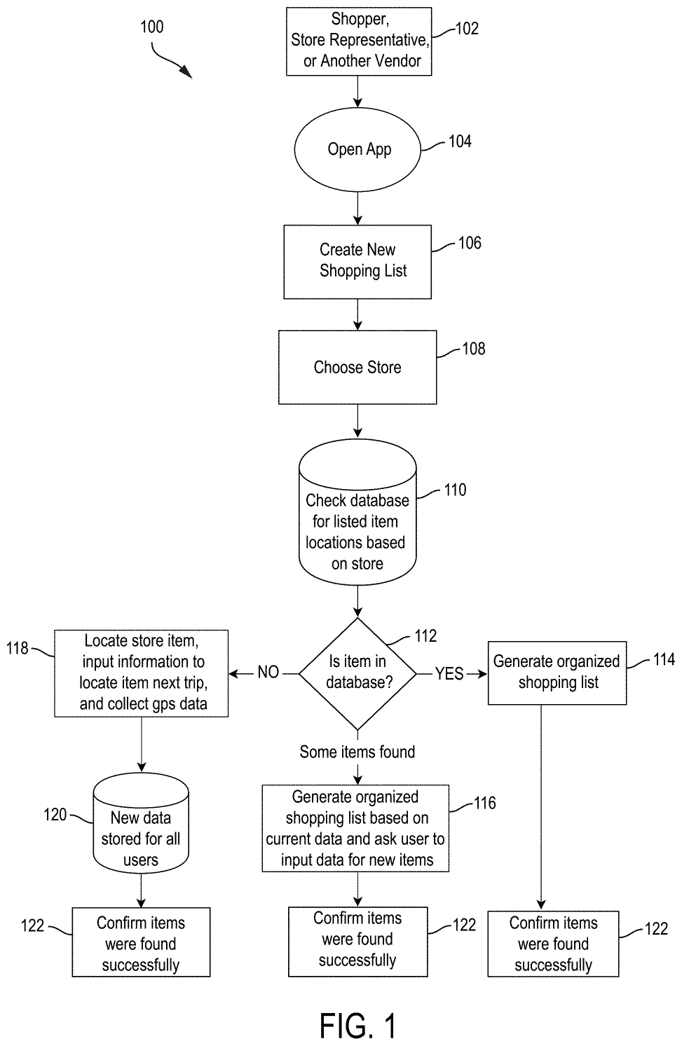

FIG. 1 presents a non-limiting example of a flow diagram 100 depicting a process taken by an organized shopping list system. In accordance with the process, a shopper, store's representative, or another vendor 102 opens 104 an organized shopping list software application on their local device. Some non-limiting examples of a local device include a mobile phone, a computer, a laptop computer, a notepad computer, and any other devices comprising digital processors capable of executing instructions to implement the organized shopping list software application. The shopper, store's representative, or another vendor 102 creates 106 a new shopping list of items they desire to purchase and then chooses a store 108. The organized shopping list system checks 110 a remote database for the locations of the items in the newly created shopping based on the store that was chosen. At this juncture, the organized shopping list system determines 112 if the item is stored in the remote database.

If only some of the items are stored in the remote database for that store, the process proceeds along the “Some items found” path, and an organized shopping list is created 116 based on the current data and the user is queried to input data for the new items not found in the remote database. The shopper, store's representative, or another vendor 102 may be queried to input the locations of the items that were not found on the remote database. For each item that is successfully found on the remote database, the organized shopping list is provided to the shopper, store's representative, or another vendor 102. The shopper, store's representative, or another vendor 102 then confirms 122 that the items were found successfully.

If all of the items are found in the remote database for that store, the process proceeds along the “YES” path and organizes 114 the shopping list for the shopper, store's representative, or another vendor 102. The shopper, store's representative, or another vendor 102 then confirms 122 that the items were found successfully.

If none of the items are found in the remote database for that store, the process proceeds along the “NO” path. The shopper, store's representative, or another vendor 102 locates 118 the store item, inputs information to locate the item on the next trip, and collects GPS data or other location tracking data. The shopping list item data entered by the shopper, store's representative, or another vendor 102 is uploaded to and stored 120 in the remote database for all shoppers. The shopper, store's representative, or another vendor 102 is asked to confirm that the items were found successfully and that none of the items had moved in the store. The shopper, store's representative, or another vendor 102 then confirms 122 that the items were found successfully.

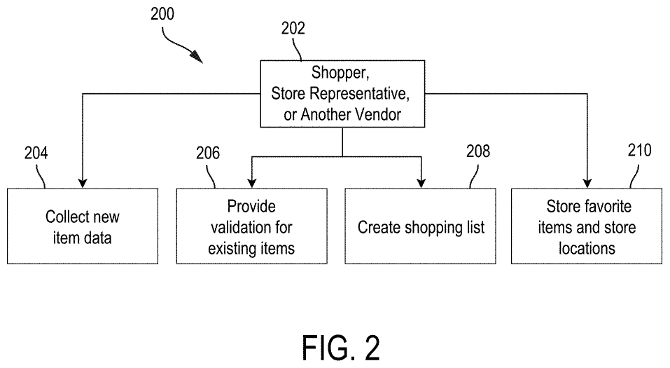

FIG. 2 presents a diagram 200 of some of the potential actions that can be taken by a shopper, store's representative, or another vendor 202 using the organized shopping list system. In one aspect, the shopper, store's representative, or another vendor 202 may collect 204 new data. In another aspect, the shopper, store's representative, or another vendor 202 may provide 206 validation for existing items or create 208 a shopping list. In another aspect, the shopper, store's representative, or another vendor 202 may store 210 favorite items and store locations in the remote database. When the shopper, store's representative, or another vendor 202 collects 204 new data, the shopper, store's representative, or another vendor 202 locates an item in a store that was not in the remote database and updates the organized shopping list system with the location of that item. This process also occurs when items in a store move to a new location that is different than the original location on the remote database. When the shopper, store's representative, or another vendor 202 provides 206 validation for existing items, the shopper, store's representative, or another vendor 202 confirms that the item location provided to them was accurate and that any updated item locations are accurate. When the shopper, store's representative, or another vendor 202 creates 208 the shopping list, the shopper, store's representative, or another vendor 202 creates an unorganized list of items that they desire to purchase. The shopper, store's representative, or another vendor 202 stores 210 favorite items and store locations where the shopper, store's representative, or another vendor 202 saves their favorite stores and items on their user profile.

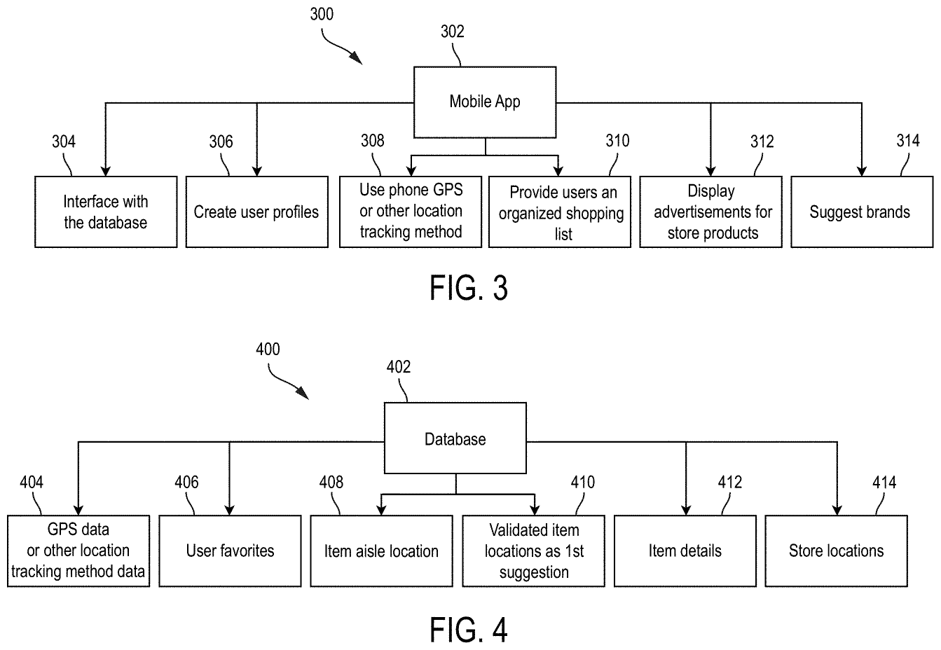

FIG. 3 presents a diagram 300 of the mobile software application's functions. Interface with the database 304, is a function where the mobile software application connects to the remote server to access information stored on a remote database. This function is often called to find the locations of items in a specific store. Create user profiles 306 is a function where a user can create a profile to store their favorite stores and items. Use phone GPS or other location tracking methods 308 is a function where the mobile software application collects GPS or other location tracking method data on where items were located in stores. The other location tracking system could be any indoor or outdoor tracking position system. Some non-limiting examples of tracking position systems could be based on GPS, QR code, radio-frequency identification (RFID), near-field communication (NFC), Bluetooth Low Energy (BLE) Beacon, WIFI, ultra wide-band, acoustic, or proximity just to provide a few examples. For example a WIFI based tracking position system would work by having a device detect multiple WIFI access points to generate a position. In general, the other location tracking method 308 could be any method that can collect the physical location of an item in the store. The software application also uses GPS or other location tracking method data to help the user find stores near them. Provide users an organized shopping list 310 is a function where the user is supplied an organized shopping list with item locations for a specific store for all the items that they provided. Display advertisements for store products 312 is a function where the mobile software application displays product advertisements for items in a store that the user frequently attends. Suggest brands 314 is a function where the mobile software application provides the best brand for an item that the user wants to purchase.

FIG. 4 presents a diagram 400 of the information stored in a remote database 402. The remote database 402, comprises GPS data or other location tracking method data 404, user favorites 406, item aisle locations 408, validated locations as 1st suggestion 410, item details 412, and store locations 414. GPS data or other location tracking method data 404 are stored GPS location data or other location tracking method data for each item found in a store. User favorites 406 are the stored items and stores that a specific user frequently uses. Item aisle locations 408 are the aisle locations for all the items in a specific store. Validated item locations as a 1st suggestion 410 is a record that the item location provided to a user was correct. If the item location is incorrect then the item location needs to be updated by the user. Item details 412 are the store details for a specific item. Some non-limiting examples of item details are bar codes, Stock Keeping Unit (SKU), Universal Product Code (UPC), and Department Class Item (DPCI) numbers. Store locations 414 are the addresses of the potentials stores that a user could purchase an item.

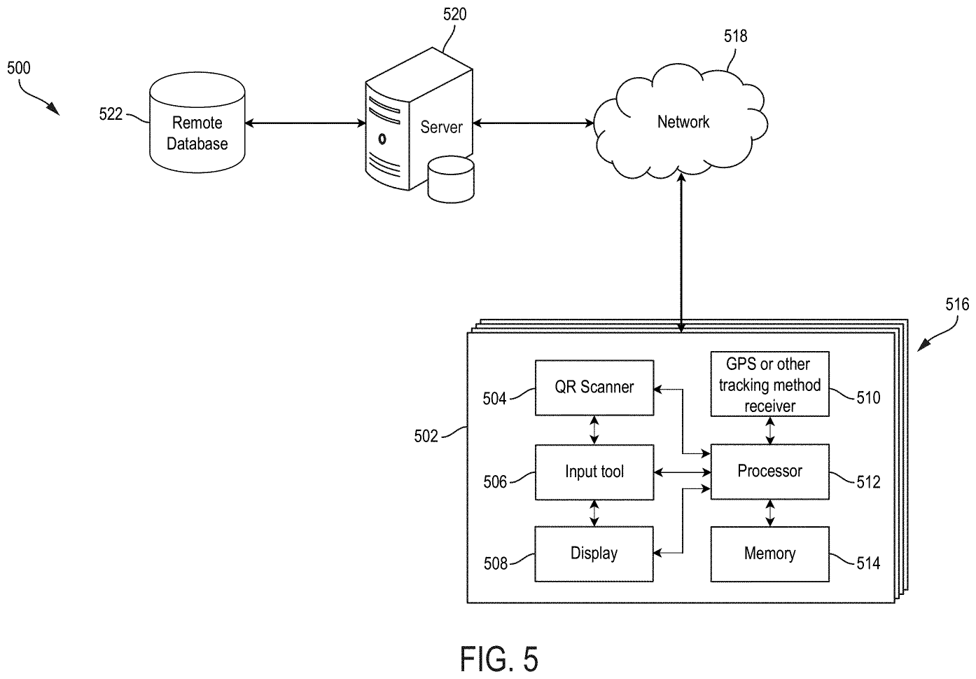

FIG. 5 presents a non-limiting example of the representation of the organized shopping list system. The diagram 500 shows the hardware that could be used in the organized shopping list system. A local device 502 comprises a QR scanner 504, an input tool 506, a display 508, a GPS or other location tracking method receiver 510, a processor 512, and a memory 514. The QR scanner 504 is used by the shopper, store's representative, or another vendor to scan the bar code of an item in the store to update and/or confirm the item's location. Additionally if the bar code would not scan the items inventory number could be entered (SKU, UPC, DPCI, etc.). The input tool 506 is used by the shopper, store's representative, or another vendor to allow them to interact with the organized shopping list system and provide information. The display 508 is used to show information to the shopper, store's representative, or another vendor. The information ranges from the shopper, store's representative, or another vendor entering items to purchase to being provided the organized shopping list for a specific store. All information from the organized shopping list system that is provided to the shopper, store's representative, or another vendor is shown on the display 508. The GPS or other location tracking method receiver 510 is used to collect local GPS or other location tracking method data on where the shopper, store's representative, or another vendor is located. This information is used to provide the shopper with store locations near them as well as to collect GPS or other location tracking method data on where items were found in the store. The processor 512 is used to provide the processing power to run the algorithms to create the organized list as well as run the different processes in the local device 502. The memory 514 works with the processor to store information. Some non-limiting examples of a local device would be a mobile phone or a computer.

Still referring to FIG. 5, the local device 502 is connected to a network 518. There are multiple local devices 516 that are connected to the network 518. Every different shopper using the organized shopping list system has a local device 502 connected to the network 518. The network 518 is used to connect a local device 502 to a server 520. The local device 502 can connect to the network 518 through a wired or wireless connection. The server 520 allows a local device 502 to access a remote database 522. The remote database 522 stores the information described in diagram 400 of FIG. 4. The local device 502 accesses the server 520 when the shopper's local device 502 needs to access information on the remote database 522. Some examples of when the local device 502 needs to access the remote database 522 are when the shopper, store's representative, or another vendor asks for an organized list from a specific store and when the shopper, store's representative, or another vendor updates item locations and details.

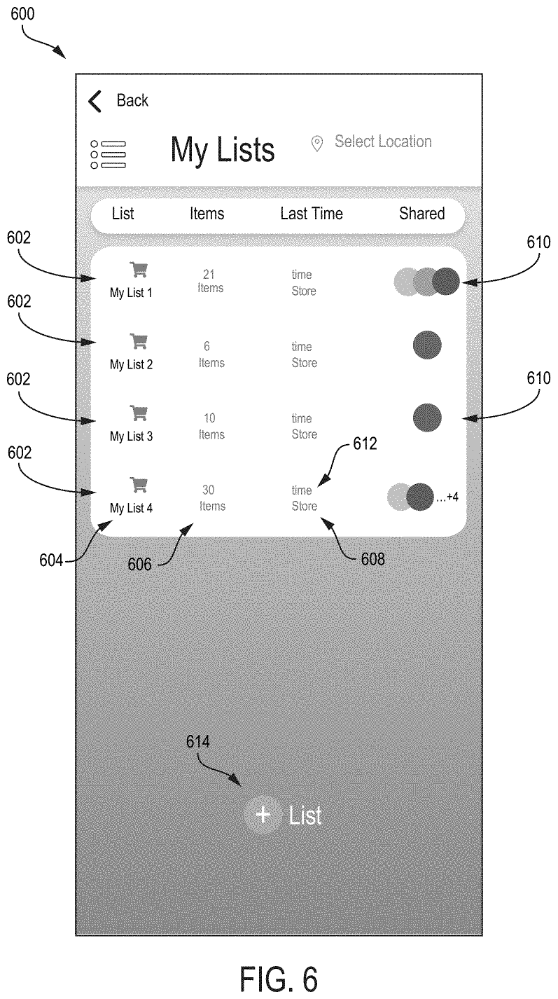

FIGS. 6-15 display example user interfaces that shoppers can interact with on a local device. FIG. 6 presents an example user interface 600 for displaying multiple shopping lists. The shopping lists 602 are displayed on the user interface 600. Some information for each list may also displayed, for example, a list name 604, a number of items 606 in the list, the amount of time 608 it took to shop for all the items on the list 602, a store location 612 for the list 602, and the profile pictures 610 for who the shopping list 602 is shared with. In an alternative embodiment, there could be more or less information displayed for each shopping list 602. Any list can be shared with any number of people that are linked through the mobile software application. By selecting the “+ List” 614 on the user interface 600 a new list can be created.

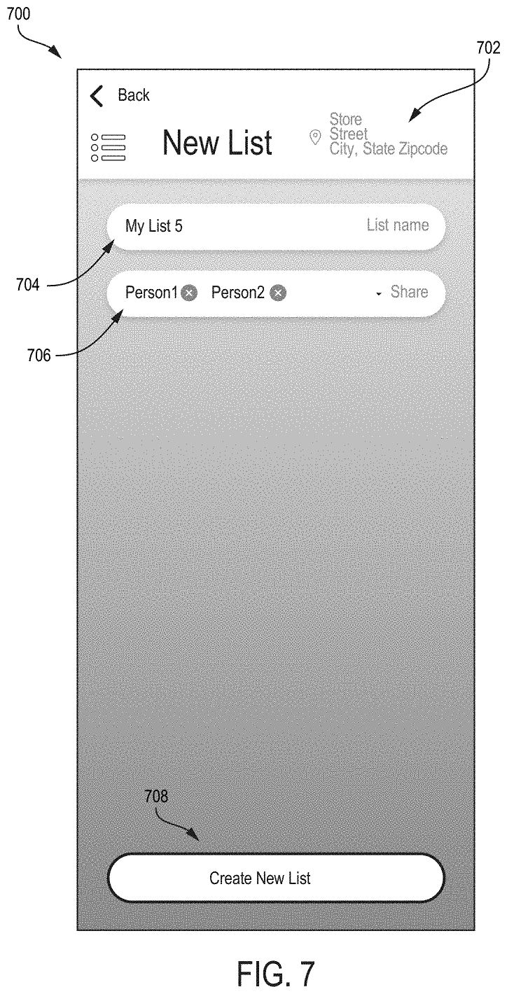

FIG. 7 presents an example user interface 700 for displaying the creation of a new shopping list. A location 702 of a store for the shopping list can be selected. A name 704 of the new shopping list can be entered. If no name is entered then a generic name of shopping list followed by a number can be entered, for example My List 5. The list can be shared 706 with any number of people. By selecting the “Create New List” 706 on the user interface 700, the new list will be created and added to the lists 602 on the example user interface 600.

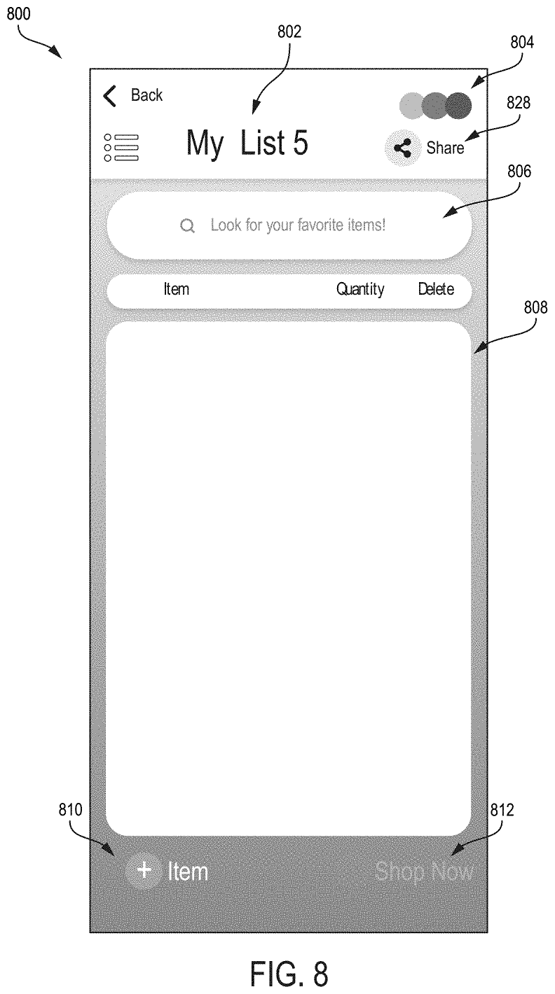

FIG. 8 presents an example user interface 800 displaying an empty new shopping list. The user interface 800 can include a list name 802, who the list is shared with 804, share list selection 828, a search selection 806, an shopping list 808, a “+ Item” 810 selection, and a “shop now selection” 812. The list name 802 can be displayed at the top of the user interface 800. The people the shopping list 808 is shared with can be displayed at the top right of the user interface, shown potentially by user profile pictures 804. The share list selection 828 allows the user to share the shopping list 808 with more people or remove people that the shopping list 808 is already shared with. The search selection 806 allows the user to search for items to add to the shopping list 808. The “+ Item” 810 selection allows the user to search and add an item to the shopping list 808. The shopping list 808 is empty once it is created and every time an item is added it is placed in the list 808. The shop now 812 selection is selected once the shopping list is complete and the user wishes to begin shopping for the items in a store.

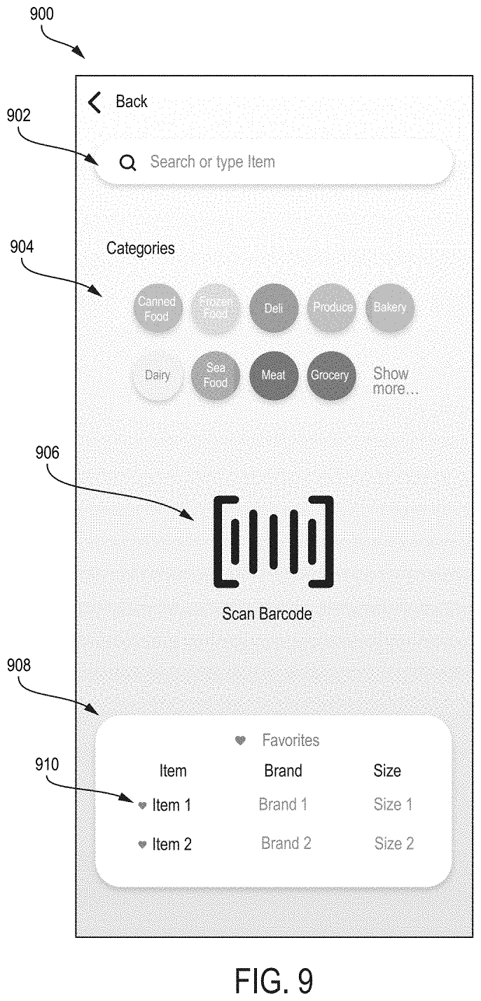

FIG. 9 presents an example user interface 900 that allows a user to locate items to add to a shopping list. The search selection 902 allows the user to enter the name of an item directly and search for a specific item in the store with that name. The categories 904 allow the user to search for an item within a list of items in a category. Some non-limiting example categories are canned food, frozen food, deli, produce, bakery, dairy, sea food, meat, and grocery. There are many more categories that are not mentioned for the sake of brevity. Any grouping of items that are sold near each other in a store can be placed into a category. The scan bar code selection 906 allows the user to scan a bar code of an item at home to search for the same item in a store. A list of the user's favorite items 908 can be displayed for the user to quickly add any of their favorite items to their shopping list. An item is added to the favorite item list 908 by selecting the heart 910 next to the item name. By selecting the favorites list 908 a list of all the user's favorite items can be brought up for the selection of a single item to add to the shopping list.

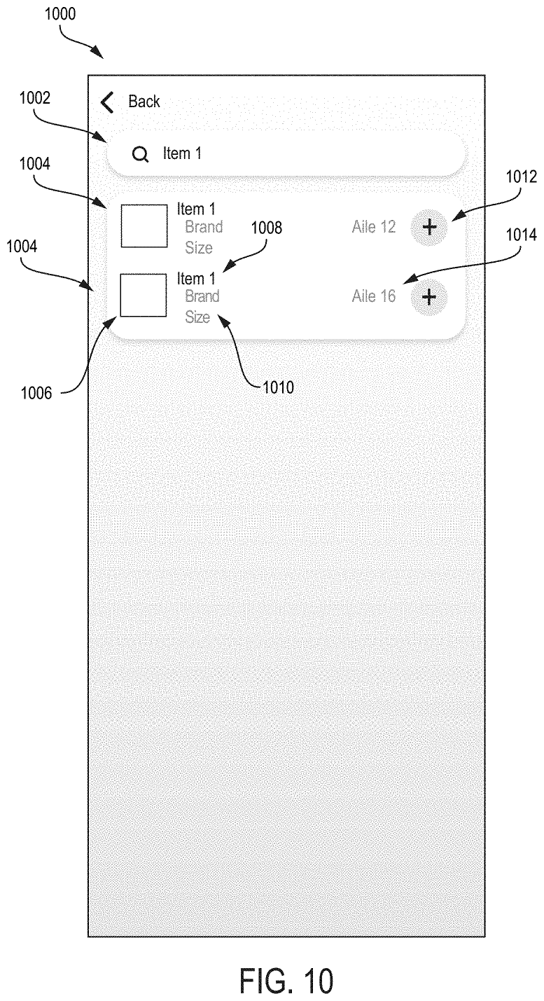

FIG. 10 presents an example user interface 1000 for searching for an item directly by name. The user can input an item name in the search bar 1002 and then items that fall under that name will appear below the search bar 1002. For example, the user entered item 1 and two different items 1004 in the store that are relevant to item 1 are shown. Some basic information is displayed for each item 1004. Some example information can include a picture 1006 of the item 1004, a name 1008 of the item 1004, the brand and size container 1010 of the item 1004 and the aisle 1014 of the item 1004. In an alternate embodiment, more or less information for each item could be displayed. A specific item can be added to the list by selecting the “+” selection 1012 for the specific item 1004 desired. Once the specific item is selected then it will appear in the shopping list 808 of the example user interface 800.

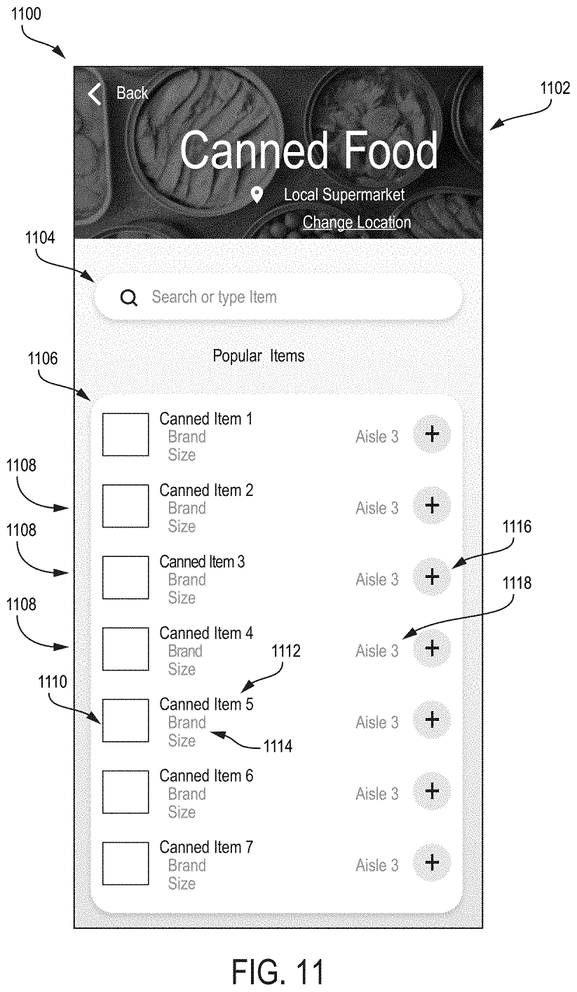

FIG. 11 presents an example user interface 1100 for searching for an item in the category of canned food. The category name 1102 provides some general information for the items that can be found in the category. The items that can be found in the category can also be relevant to the store associated with the shopping list that is being used. The store name can be displayed on the user interface 1100, for example, the store information can be displayed below the category name. The search bar 1104 allows the user to search within the category for a specific item. The search bar 1104 can limit the number of items being displayed in the category. The list of items 1106 for the category is displayed along most of the user interface 1100. Each item 1108 in the list 1106 has some basic information displayed. For example, a picture 1110 of the item 1108, a name 1112 for the item 1108, brand and size information 1114 for the item 1108, and an aisle location 1118 for the item 1108 are just some non-limiting examples of the information that could be displayed. In an alternate embodiment, more or less information for each item 1108 in the list 1106 could be displayed. A specific item 1108 can be selected to be added to the shopping list 808 by selecting the “+” selection for that item 1108.

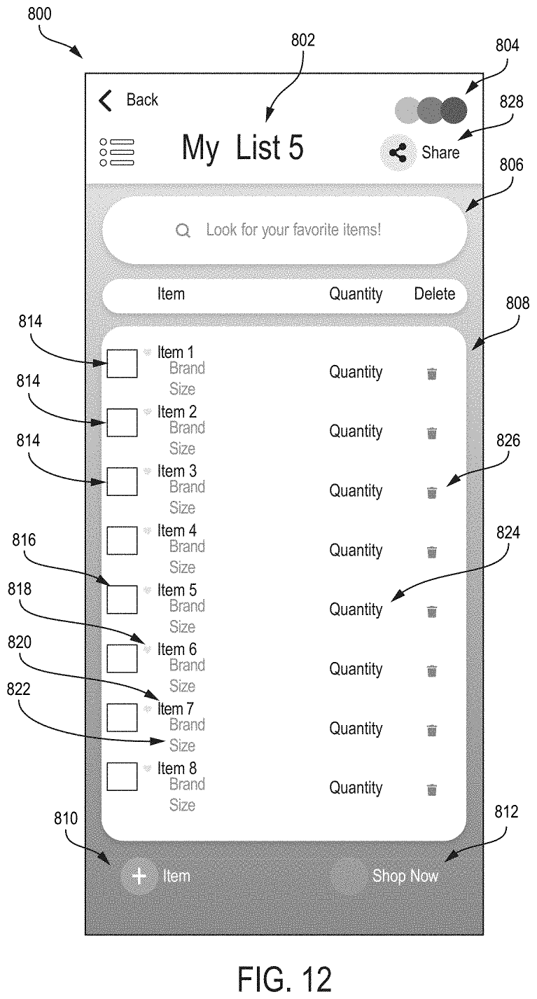

FIG. 12 presents an example user interface 800 where shopping items 814 have been selected and added to the shopping list 808. The name 802 of the shopping list can be displayed at the top of the user interface 800. The share list selection 828 allows the user to change the list of people that the shopping list 808 is shared with. For example, the shopping list 808 can be shared with 3 people shown by the 3 user profile pictures 804. The search selection 806 allows the user to search for items to add to the shopping list 808. The “+ Item” 810 selection allows the user to search and add an item to the shopping list 808. The items 814 in the shopping list 808 contain some information for each item. For example, a picture 816 of the item 814, information on if the item is favorited or not, an item name 820 of the item 814, brand and size information 822, and a quantity 824 of the item 814 to purchase are all information that can be on the shopping list 808 for each item 814. In alternative embodiments, there can be more or less information displayed for each item 814. The user can favorite an item by selecting the heart icon 818 next to the item name 820. The user can remove an item 814 from the shopping list 808, for example, by selecting the trash can icon 826 of the item 814. In alternative embodiments, there could be any number of methods to remove an item 814 from the shopping list 808. Once the shop now 812 selection is selected the shopping list 808 is organized into an organized shopping list that allows the user to begin shopping efficiently in the store selected when the shopping list was created.

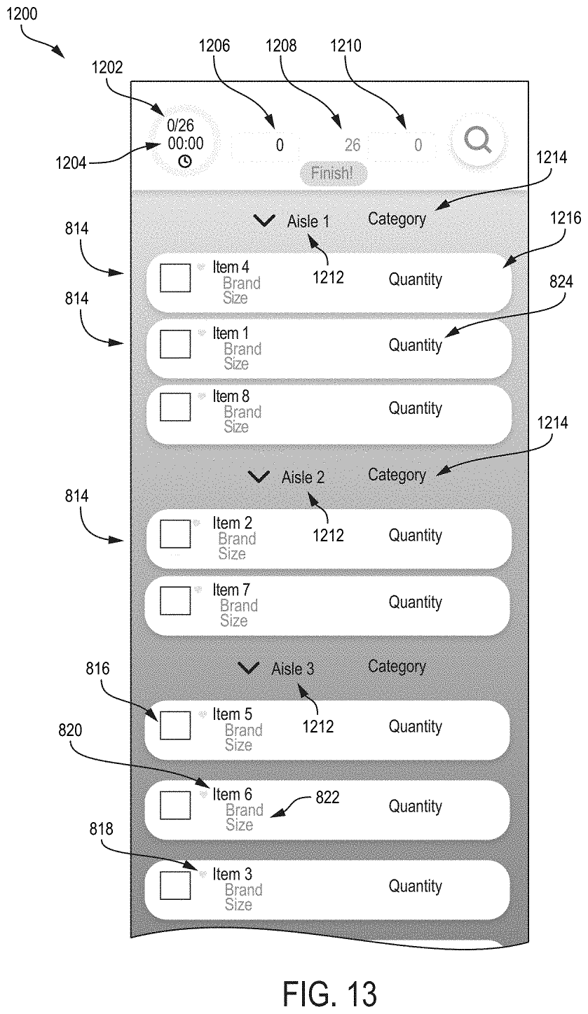

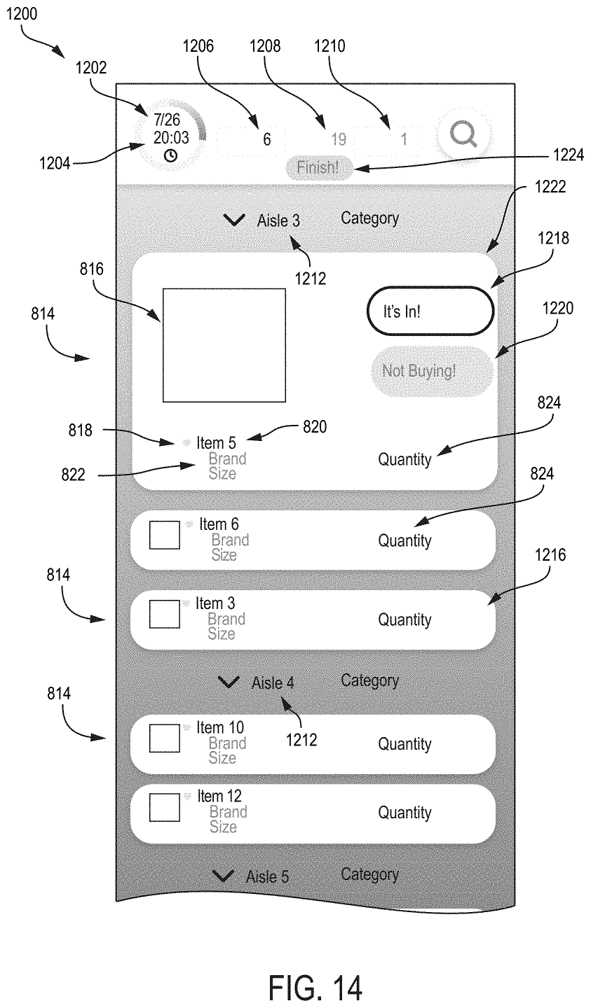

FIGS. 13 and 14 present an example user interface 1200 displaying an organized shopping list. FIG. 13 presents the example user interface 1200 right after the user selected shop now 812 of user interface 800 (FIG. 12). The user interface 1200 shows the number of items in the shopping cart 1202 from the total on the shopping list. For example, in FIG. 13 zero items have been gathered of the 26 items on the shopping list. It also shows the amount of time 1204 the user has spent shopping. The top of the user interface 1200 may show the number of items in the cart 1206, the number of items left to be found 1208 in the store, and the number of items that are not being purchased 1210. The items 814 in the shopping list 808 (FIG. 12) are organized into the order to gather the items from aisles in the store. The items 814 are grouped by aisle number 1212 and have an aisle category 1214 for each aisle. The items 814 in the shopping list 808 (FIG. 12) contain some information for each item. For example, a picture 816 of the item 814, an item name 820 of the item 814, brand and size information 822, and a quantity 824 of the item 814 to purchase are all information that can be on the organized shopping list for each item 814. In alternative embodiments, there can be more or less information displayed for each item 814.

FIG. 14 present an example user interface 1200 displaying an organized shopping list in the middle of gathering the items in the store. For example, 7 items have been removed from the shopping list out of the 26 items on the example organized shopping list. The user interface 1200 shows that 6 items have been placed in the cart 1206, there are 19 items left to be found 1208 in the store, and 1 item is not being purchased 1210. When an item on the organized shopping list is selected, it can be enlarged, for example, as shown at 1222. The user can then specify if the selected item 814 is placed in the cart by selecting the “It's In!” selection 1218 or if the selected item is not being purchased by selecting the “Not Buying!” selection 1220. Once the user has finishing gathering items, they can select the “Finish!” selection 1224.

When selecting items to add to the shopping list 808 (FIG. 12), some of the item locations might not be in the remote database. If this happens, the user can be informed that the item location is not known and during gathering items the user is provided the opportunity to help update the remote database with the item location in the store. Additionally, some items might be moved in the store and the item location provided to the user in the organized shopping list could be incorrect and might need updated.

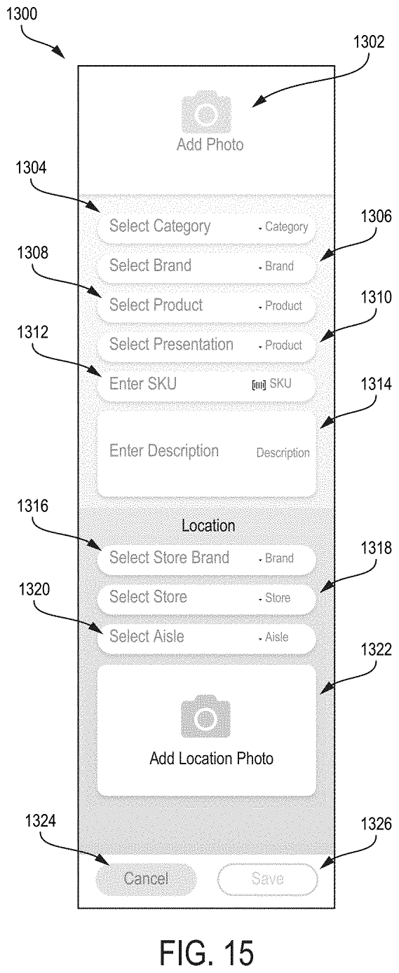

FIG. 15 presents an example user interface 1300 that allows a user to help update an item location on a remote database of item locations by providing item information to the remote server. The remote server can later use the information from multiple users to update the remote database. The user interface 1300 allows the user to provide information about the location of an item in a store. Some non-limiting examples of the information that the user can provide about the location of an item are a photo 1302 of the item, a category 1304 for the item, a brand 1306 for the item, a product 1308 for the item, a presentation 1310 of the item, a stock keeping unit (SKU) 1312 of the item, a description 1314 of the item, a store brand 1316, a store 1318 that the item is located in, the aisle number 1320 that the item is located, and a photo of the location of the item in the aisle. Once the user has provided the information for updating the location of the item, the user can then save 1326 the information or cancel 1324 storing the information. The category 1304 of the item can be a group of items that are similar and sold in the store. The brand 1306 is the brand of the item being purchased. The product 1308 can be information about the type of item, for example ketchup. The presentation 1310 can be information about how the item is packaged, for example a 16 FL. OZ. bottle. The store brand 1316 can be information about the type of store, for example the local super market. The store 1318 can be information about the exact store such as the local supermarket at a specific address. In an alternative embodiment, more or less information could be sent to help update the remote database by the user.

### EXAMPLES

Various aspects of the subject matter described herein are set out in the following numbered examples.

Example 1—a system for generating an organized shopping list. The system comprising a remote database, a remote server configured to access content stored in the remote database, and a local device coupled to the remote server by a network. The local device comprises an input tool for entering items to purchase, and a display. In response to selecting a store to purchase the items, the local device is configured to communicate with the remote server to access the remote database, compare a list of purchase items with a list of items stored in the remote database, and generate a list of items that are on the remote database for the selected store and a list of items that are missing from the remote database for the selected store. In response to selecting a store to purchase the items, the local device is further configured to calculate an efficient order to gather the purchase items that are on the remote database for the selected store, and generate an organized list of the purchase items detailing their location in the store using the calculated order, wherein purchase items not on the remote database for the selected store do not have a location and require one to be added. In response to selecting an item on the organized list as located with the input tool, the local device is configured to validate that the item was in the appropriate location with the input tool, and send the validated item location to the remote server, wherein the remote server updates the remote database.

Example 2—the system of Example 1, wherein the local device further comprises a GPS or other location tracking method receiver.

Example 3—the system of Examples 1 or 2, wherein the store is selected using local device GPS or other location tracking method data.

Example 4—the system of Examples 1, 2, or 3, wherein the local device further comprises a QR scanner.

Example 5—the system of Example 4, wherein the local device is further configured to add or modify an item location for the selected store by scanning the barcode of the item with the QR scanner and entering a new item location with the input tool, collect GPS or other location tracking method data upon entry of an item location, and send the updated item location and GPS or other location tracking method information to the remote server, wherein the remote server updates the remote database.

Example 6—the system of Examples 1, 2, 3, 4, or 5, wherein the remote database content comprises: GPS data or other location tracking method data, user favorites, item aisle locations, validated item locations, item details, and store locations.

Example 7—the system of Examples 1, 2, 3, 4, 5, or 6, wherein the local device is further configured to generate user profiles.

Example 8—a device used to generate an organized shopping list for a batch of items to be purchased at a selected store. The device comprising a processor, a memory, a display, and an input tool. In response to entering purchase items with the input tool and selecting a store to purchase the items the device is configured to communicate with a remote server through a network to access a remote database, compare the list of purchase items with a list of items stored in the remote database, and generate a list of items that are stored in the remote database for the selected store and a list of items that are missing from the remote database for the selected store. In response entering purchase items with the input tool and selecting a store to purchase the items the device is further configured to calculate an efficient order to gather the purchase items that are on the remote database for the selected store, and generate an organized list of the purchase items detailing their location in the store using the calculated order, wherein purchase items not on the remote database for the selected store do not have a location and require one to be added. In response to selecting an item on the organized list as located with the input tool, the device is configured to validate that the item was in the appropriate location with the input tool, and send the validated item location to the remote server, wherein the remote server updates the remote database.

Example 9—the device of Example 8, wherein the device further comprises a GPS or other location tracking method receiver.

Example 10—the device of Examples 8 or 9, wherein the local device further comprises a QR scanner.

Example 11—the device of Example 10, wherein the device is further configured to add or modify an item location for the selected store by scanning the barcode of the item with the QR scanner and entering a new item location with the input tool, collect GPS or other location tracking method data upon entry of an item location, and send the updated item location and GPS or other location tracking method information to the remote server, wherein the remote server updates the remote database.

Example 12—the device of Examples 8, 9, 10, or 11, wherein the remote database content comprises: GPS data or other location tracking method data, user favorites, item aisle locations, validated item locations, item details, and store locations.

Example 13—the device of Examples 8, 9, 10, 11, or 12, wherein the device is further configured to generate user profiles.

Example 14—a device that generates an organized shopping list when provided items and a store to purchase the items, the device is configured to communicate with a remote server through a network to access a remote database, compare a list of purchase items with a list of items stored in the remote database, and generate a list of items that are on the remote database for the selected store and a list of items that are missing from the remote database for the selected store. The device is further configured to calculate an efficient order to gather the purchase items that are on the remote database for the selected store, and generate an organized list of the purchase items detailing their location in the store using the calculated order, wherein purchase items not on the remote database for the selected store do not have a location and require one to be added, validate that an item was in the appropriate location, and send a validated item location to the remote server, wherein the remote server updates the remote database.

Example 15—the device of Example 14, wherein the device is further configured to add or modify an item location for the selected store by scanning the barcode of the item and entering a new item location, and send the updated item location to the remote server, wherein the remote server updates the remote database.

Example 16—the device of Examples 14 or 15, wherein the device is further configured to generate user profiles.

1. A system for generating an organized shopping list, the system comprising:
a remote database;
a remote server configured to access content stored in the remote database; and
a local device coupled to the remote server by a network, wherein the local device comprises an input tool for entering items to purchase, and a display;
wherein, in response to selecting a store to purchase the items, the local device is configured to:
communicate with the remote server to access the remote database;
compare a list of purchase items with a list of items stored in the remote database;
generate a list of items that are on the remote database for the selected store and a list of items that are missing from the remote database for the selected store;
calculate an efficient order to gather the purchase items that are on the remote database for the selected store; and
generate an organized list of the purchase items detailing their location in the store using the calculated order, wherein purchase items not on the remote database for the selected store do not have a location and require one to be added;
wherein, in response to selecting an item on the organized list as located with the input tool, the local device is configured to:
validate that the item was in the appropriate location with the input tool; and
send the validated item location to the remote server, wherein the remote server updates the remote database.

2. The system of claim 1, wherein the local device further comprises a GPS or other location tracking method receiver.

3. The system of claim 2, wherein the store is selected using local device GPS or other location tracking method data.

4. The system of claim 2, wherein the local device further comprises a QR scanner.

5. The system of claim 4, wherein the local device is further configured to:
add or modify an item location for the selected store by scanning the barcode of the item with the QR scanner and entering a new item location with the input tool;
collect GPS or other location tracking method data upon entry of an item location; and
send the updated item location and GPS or other location tracking method information to the remote server, wherein the remote server updates the remote database.

6. The system of claim 1, wherein the remote database content comprises: GPS data or other location tracking method data, user favorites, item aisle locations, validated item locations, item details, and store locations.

7. The system of claim 1, wherein the local device is further configured to generate user profiles.

8. A device used to generate an organized shopping list for a batch of items to be purchased at a selected store, the device comprising:
a processor,
a memory,
a display, and
an input tool, wherein in response to entering purchase items with the input tool and selecting a store to purchase the items the device is configured to:
communicate with a remote server through a network to access a remote database;
compare the list of purchase items with a list of items stored in the remote database;
generate a list of items that are stored in the remote database for the selected store and a list of items that are missing from the remote database for the selected store;
calculate an efficient order to gather the purchase items that are on the remote database for the selected store; and
generate an organized list of the purchase items detailing their location in the store using the calculated order, wherein purchase items not on the remote database for the selected store do not have a location and require one to be added;
wherein, in response to selecting an item on the organized list as located with the input tool, the device is configured to:
validate that the item was in the appropriate location with the input tool; and
send the validated item location to the remote server, wherein the remote server updates the remote database.

9. The device of claim 8, wherein the device further comprises a GPS or other location tracking method receiver.

10. The device of claim 9, wherein the local device further comprises a QR scanner.

11. The device of claim 10, wherein the device is further configured to:
add or modify an item location for the selected store by scanning the barcode of the item with the QR scanner and entering a new item location with the input tool;
collect GPS or other location tracking method data upon entry of an item location; and
send the updated item location and GPS or other location tracking method information to the remote server, wherein the remote server updates the remote database.

12. The device of claim 8, wherein the remote database content comprises: GPS data or other location tracking method data, user favorites, item aisle locations, validated item locations, item details, and store locations.

13. The device of claim 8, wherein the device is further configured to generate user profiles.

14. A device that generates an organized shopping list when provided items and a store to purchase the items, the device is configured to:
communicate with a remote server through a network to access a remote database;
compare a list of purchase items with a list of items stored in the remote database;
generate a list of items that are on the remote database for the selected store and a list of items that are missing from the remote database for the selected store;
calculate an efficient order to gather the purchase items that are on the remote database for the selected store; and
generate an organized list of the purchase items detailing their location in the store using the calculated order, wherein purchase items not on the remote database for the selected store do not have a location and require one to be added;
wherein, in response to selecting an item on the organized list as located with the input tool, the device is configured to:
validate that the item was in the appropriate location with the input tool; and
send the validated item location to the remote server, wherein the remote server updates the remote database.

15. The device of claim 14, wherein the device is further configured to:
add or modify an item location for the selected store by scanning the barcode of the item and entering a new item location; and
send the updated item location to the remote server, wherein the remote server updates the remote database.

16. The device of claim 14, wherein the device is further configured to generate user profiles.
